(19) United States
(12) Patent Application Publication
(10) Pub. No.: US 2022/0002957 A1
(43) Pub. Date: Jan. 6, 2022

(54) ASSEMBLY OF A PRIMARY DELIMITING ELEMENT AND A SECONDARY DELIMITING ELEMENT FOR A GATE SYSTEM, USE OF SUCH AN ASSEMBLY, AND PRIMARY DELIMITING ELEMENTS AND/OR SECONDARY DELIMITING ELEMENTS FOR SUCH AN ASSEMBLY

(71) Applicant: COMPANEER GMBH, München (DE)

(72) Inventors: Jochen LERCHE, Andechs (DE); Thomas ALBINGER, München (DE)

(21) Appl. No.: 17/293,099

(22) PCT Filed: Nov. 21, 2019
(86) PCT No.: PCT/EP2019/082115

§ 371 Date: May 12, 2021

(30) Foreign Application Priority Data
Nov. 22, 2018 (DE) 10 2018 129 449.2

(51) Int. Cl. E01F 13/02; E06B 11/08

(52) U.S. Cl. CPC E01F 13/022; E06B 11/085

(57) ABSTRACT

Arrangement of at least one primary limiting element and at least one secondary limiting element for a sluice system, in particular in the access area of an event site, where the primary limiting element includes a dimensionally stable primary guide element extending longitudinally in the access direction and/or the secondary limiting element includes a dimensionally stable secondary guide element extending longitudinally in the access direction, where at least the primary limiting element is reversibly transferable between an operating state and a stowed state, where in the operating state a passage extending in the access direction is formed between the primary limiting element and the secondary limiting element, and where for widening the passage in the stowed state at least the primary limiting element, in particular the entire primary limiting element, is stowed.

The present invention relates to an arrangement of a primary limiting element and a secondary limiting element for a sluice system, a use of such an arrangement and a primary limiting element and/or a secondary limiting element for such an arrangement.

Sluice systems are sufficiently known from the prior art, which are used in the access area of an event site to grant visitors-controlled access to an event site. Typically, several access passages are arranged in a row next to each other, and in one entrance area of the respective access passage, a steward or security personnel is dedicated to the individual control of the visitors.

In particular, it is desirable to provide as many individual access passages as possible, each of which permits the individual control of each visitor. The access passages should preferably be dimensioned in such a way that visitors cannot force their way past the security personnel. However, the number of potential access passages is limited by security regulations, which require that a sufficiently wide passage be provided for escape in the event of an emergency. Access passages are often not suitable as escape routes due to their width.

It is therefore a task of the present invention to provide an arrangement of limiting elements with which the highest possible number of access passages can be realized, taking into account any safety regulations for escape.

This task is solved by an arrangement of a primary limiting element and a secondary limiting element for a sluice system according to claim 1, a use of the arrangement according to claim 10 and a primary and/or secondary limiting element according to claim 11. Further advantages and features of the invention result from the dependent claims as well as the description and the attached figures.

According to a first aspect of the present invention, an arrangement of at least one primary limiting element and at least one secondary limiting element is provided for a sluice system, in particular in the access area of an event site, wherein at least the primary limiting element comprises a dimensionally stable primary guide element extending longitudinally in the access direction and/or the secondary limiting element comprises a dimensionally stable secondary guide element extending longitudinally in the access direction, the primary limiting element being reversibly transferable between an operating state and a stowed state, a passage extending in the direction of access being formed between the primary limiting element and the secondary limiting element in the operating state, and at least the primary limiting element, in particular the entire primary limiting element, being stowed in order to widen the passage in the stowed state.

Compared to the prior art, it is provided according to the invention that at least the primary limiting element or primary delimiting element can be stowed in the stowed state, whereby a width of the passage along which visitors can leave the event site can be increased. Thus, for example, by assuming the stowed state of the primary limiting element, the required escape route width can be established in the event of a regulated escape from an event site. Also, the normal exiting of the event area is thereby significantly improved or facilitated in an advantageous manner. Preferably, the primary limiting element is transferred as a whole to the stowed state without its dimensions being changed, for example by folding or rolling it up, to realize the stowed state. In the operating state, the primary limiting element is preferably configured in such a way that a passage, in particular an access passage, is formed, which is suitable for controlling the visitors individually. A passage can be a passage through which persons (for example visitors) can pass. In particular, a passage may have a longitudinal extension in the access direction. In particular, the passage may have a length between 0.6 m and 5 m or between 1 m and 3 m, preferably between 1.1 m and 2.5 m, and more preferably between 1.1 m and 1.5 m. In other words, a passage can have a length such that 2 to 3 people can stand in it, especially one behind the other. Preferably, the passage in the operating state has a width perpendicular to the access direction of about 45 cm to 90 cm, preferably of about 60 cm to 90 cm. It is also conceivable that at least one passage is designed for a handicapped-accessible condition and has a width of 1.00 m, 1.20 m or 1.50 m. The passage must be passed through by visitors in the direction of access. Visitors have to pass through this passage in the access direction to get from the outdoor area of an event site to an indoor area of the event site. Further, a width of the sluice system or lock system and a width of a passage provided therein may have a ratio that is between 2 and 2.5 preferably between 2.1 and 2.3. Preferably, the sluice system has a height of between 80 cm and 120 cm. The secondary limiting element may have a height of from 1.50 m to 2.50 m, preferably from 1.90 m to 2.30 m, more preferably from about 2.20 m. The primary limiting element may have a height of from 40 cm to 150 cm, preferably from 60 cm to 120 cm.

The present invention provides an arrangement for a sluice system, in particular for a personnel sluice, which can be used bidirectionally and which, when used as an escape route, provides a minimum loss of escape route width. In this context, bidirectional means that both a function of a separation system or a personnel sluice in the direction of access and a function as an escape route in the direction of exit are fulfilled. In addition, the arrangement for the sluice system is designed in such a way that there are no sharp edges on it. This ensures that no one is injured even when there is a large number of people.

The use of a dimensionally stable primary or secondary guide element is an advantageous way of ensuring that the primary and/or secondary limiting elements or boundary elements cannot be deformed in the controlled area, particularly in the event of crowding in the crowd of visitors, but continue to serve to separate the individual passages arranged next to one another and thus prevent visitors from pushing past the security personnel in an uncontrolled manner. For example, the primary and/or secondary guiding elements are formed as bars or spars or railings, respectively, which delimit the respective passages on both sides. A passage in the operating state is understood by the skilled person to be a corridor whose length in the direction of access is greater than its width perpendicular to the direction of access. Alternatively, the length in the access direction of the passage can also be equal to the width dimensioned perpendicular to the access direction. For example, the passage may be 60 cm wide and 60 cm long. Preferably, the primary limiting element and the secondary limiting element or secondary delimiting element are a bracket-like or U-shaped element, from which rod-like or tie-bar-like, primary or secondary guide element posts protrude, in particular vertically. Preferably, the posts are formed at the ends of the primary and/or secondary guide element for realizing the bracket-like shape of the primary and/or secondary limiting element. Preferably, the primary and/or the secondary limiting element are formed as hollow bodies or only the primary limiting element to be stowed is formed as a hollow body, whereby the weight of the primary limiting element to be stowed can be advantageously reduced.

Preferably, the primary guide element and/or the secondary guide element extends along the access direction over a length of between 1 m and 3 m, preferably between 1.1 and 2.5 m, and more preferably between 1.1 and 1.5, and has a transverse extension perpendicular or transverse to the access direction of between 3 cm and 20 cm, preferably between 3 cm and 8 cm, more preferably of about 5 cm.

Preferably, the arrangement or the sluice system formed by the arrangement is located upstream of a further control device along the access direction. In particular, it is intended that the further control device has a shorter average check-in time than the sluice system. For example, only the access authorization, for example a ticket, is checked at the further control device, while the visitors are checked in the sluice system to determine whether they are carrying an object that is prohibited on the event site. Furthermore, several of the arrangements according to the invention can also be arranged in a staggered manner. In this regard, the individual arrangements or the sluice system formed by the arrangement may be interconnected by fence elements associated with the product. For example, fence elements may have a height of about 220 cm and a mesh size of about 25 mm×200 mm or 25 mm×25 mm or 50 mm×50 mm. Further, the arrangement for a sluice system may include a barrier element such as a lock or crossbar, so that if multiple sluice systems are provided, individual sluice systems may be closed when not in use. In this way, it is possible to react even more actively to changes in the number of people and to ensure that sluice systems that are not in use can be closed without supervision.

Furthermore, it is preferably provided that the secondary limiting element differs from the primary limiting element in that the secondary limiting element is firmly anchored in the ground or floor and remains positionally fixed, i.e. in its alignment and position, permanently or lifelong unchanged, while the primary limiting element is designed to be mobile, i.e. the primary limiting element can, for example, be detached from the ground or displaced by a translational movement in such a way that it can be transferred to the desired stowed position. It is emphasized once again that even in this exemplary embodiment, in which only the second secondary limiting element is firmly anchored in the ground, the primary limiting element remains mobile, i.e. it can be detached from the ground.

Preferably, the arrangement for a sluice system (i.e., in particular for a personnel sluice) can be assembled and disassembled. In other words, the sluice system formed by the arrangement can be designed to be dismountable so that it can be deployed and used in particular at different locations. In this context, the sluice system can be transferred from an assembled state (i.e., in particular, an operating state) to a transport state (collapsed state). In the transport state, the sluice system can then be advantageously transportable. Alternatively, the lock system formed by the arrangement can also be provided immobile, i.e. permanently at one location.

In a further embodiment, the arrangement for a sluice system (i.e., in particular for a personnel sluice) or the sluice system formed by the arrangement can provide ground level compensation by means of adjustment elements provided on the arrangement. In particular, these adjusting elements can be provided in an edge portion of the arrangement and/or of the sluice system and can be adjusted individually. In this way, a difference in level of up to about 4% from the ground on which the arrangement stands can be advantageously compensated. For example, the adjusting elements can be adjustable feet.

The present invention thus provides an arrangement for a sluice system or a sluice system formed by the arrangement, in which the available escape route width can be used almost completely as an access, in particular as an access with a control sluice. This is achieved by arranging the primary limiting element in the stowed state in such a way that it does not form a barrier, but is stowed in the longitudinal direction in such a way that a widened passage is released.

According to a preferred embodiment, the primary and/or secondary limiting element is provided with a quick release mechanism for releasing the primary and/or secondary limiting element from a fastening element in which the primary and/or secondary limiting element is fastened in the operational state. By using a quick release mechanism, security personnel can advantageously quickly release the primary limiting element from its attachment and stow it accordingly.

For example, the quick release mechanism comprises a Bowden cable or the like which allows the quick release mechanism to have an actuator in the upper third of the primary and/or secondary restraining element to release the attachment at the end of the post facing the ground. A significant advantage of the quick release mechanism is the quick and easy release of the primary and/or secondary limiting element, whereby, for example, in an emergency situation, the stowed state can be quickly and easily initiated or effected by a steward or security personnel. Thus, the steward or the security personnel does not have to loosen the fastening of the primary and/or secondary fastening element at the floor, but can conveniently and quickly initiate the loosening of the primary and/or secondary limiting element from the corresponding fastening element. It is also conceivable that the actuator is arranged halfway up the post. It is also conceivable that the arrangement comprises a recognition system that recognizes those who are authorized to release the limiting element from the fastening element. For example, this is an electronic recognition system in which a steward and/or security personnel with a corresponding identification element, such as an RFID chip, initiates an actuator within the limiting element to release the limiting element from the fastening element when the corresponding identification element comes within detection range of a corresponding sensor of the recognition system embedded in the primary and/or secondary limiting element.

It is also conceivable that the quick-release mechanism can be triggered by an escaping person (i.e., also by a person who is not an security personnel or the like) via a triggering device (for example, a panic button). In this context, the release device can be designed similar to an escape door (i.e. similar to a function of the escape door and/or similar to a design of a fitting of the escape door).

According to a preferred embodiment of the present invention, it is provided that in the stowed state the primary limiting element is suspended from the secondary limiting element or retracted in the floor. In this context, it is conceivable that, for example, the primary guiding element can be transferred between the operating state and the stowed state by means of a scissor-type system. This allows, for example, the primary limiting element to be completely retracted into the floor and the passage to be widened for the escape state. Visitors can then step over the primary limiting element when exiting the event area. It is also conceivable to sink the supporting structure of the limiting element vertically.

The primary limiting element can preferably be suspended from the secondary limiting element manually, thus advantageously eliminating the need for complex motorized systems or lifting devices that may be exposed to the weather conditions at the event site. The steward can thereby quickly detach the primary limiting element from a corresponding fastening element and hang it on the secondary limiting element. It is conceivable, for example, that the secondary limiting elements have corresponding holders and/or suspension devices, e.g. a hook element, on which the primary limiting element can be suspended in the stowed state.

In a particularly preferred embodiment of the present invention, it is provided that the primary limiting element and/or the secondary limiting element comprises a functional element, for example a storage space, a folding chair element or a garbage bag fastening, which is transferable between a state of use and a state of non-use and/or that the functional element is connected to the primary limiting element or secondary limiting element at least in the operating state, in particular detachably. In this way, the functional element can be integrated into the primary limiting element in an advantageous manner, for example by being mounted on the primary limiting element in a hinged or pivotable manner. This allows the functional element to be generally transferred between a use state and a non-use state by a simple hand movement. Furthermore, the functional element may be an element, in particular a fixed element, having a width perpendicular to the access direction of from 40 cm to 80 cm, preferably of about 60 cm. In the state of use, the storage space, the folding chair element or the trash bag attachment support the security personnel in controlling the visitors. For example, the storage space can be used to place a handbag that needs to be checked. The trash bag attachment is used for detachably mounting a trash bag in which, for example, empties that may not be brought onto the event premises can be disposed of. It is also conceivable that a folding chair element, in particular a seat, is pivotably arranged on the primary limiting element. Such a seat element can be used, for example, by the security personnel to sit on it himself or, for example, to allow a visitor to be checked to take a seat there if he wishes to check his shoes. The integration of the functional element into the primary limiting element has in particular the advantage that the primary limiting element can be stowed together with the functional element without having to take additional stowage measures for the functional element. Alternatively, it is also conceivable that the functional element can be connected to the primary limiting element and/or secondary limiting element for realizing the operating state, for example by being hooked in or laid on in the operating state, and can be released from the primary limiting element and secondary limiting element again for transfer to the stowed state. The trash bag attachment is preferably a strut which runs transversely to the access direction between a primary limiting element and a secondary limiting element or between two adjacent primary limiting elements. Corresponding trash bags can then be fastened to the strut. Furthermore, it is preferably provided that the primary limiting element is configured in such a way that functional elements can be selectively interchangeably mounted on the primary limiting element. This allows the primary limiting elements to be individually designed or adapted as required. For example, a storage space can be reversibly exchanged for a trash bag fastening device.

Preferably, it is provided that the primary limiting element is dimensioned, in particular dimensioned with regard to its size, in such a way that the primary limiting element can be plugged onto the secondary limiting element. By plugging the primary limiting element onto the secondary limiting element, it is avoided that the primary limiting element is arranged laterally on the secondary limiting element and thus would reduce the passage again. In addition, the attachment can be easily realized by the security personnel.

According to a particularly preferred embodiment of the present invention, it is provided that in the stowed state, the primary guide element and the secondary guide element interact in a form-fitting manner in a direction running parallel and/or transverse to the access direction. This significantly improves the stability of the connection between the primary limiting element and the secondary limiting element in the stowed state and prevents the primary limiting element from accidentally detaching from the secondary limiting element in an escape situation, for example, and blocking the passage or even injuring visitors who want to leave the event area. For the positive-locking design, it is preferably provided that the primary guide element has a profiling on its underside and the secondary guide element has a profiling on its upper side, which are preferably designed complementary to each other, so that the primary guide element and the secondary guide element interact positively in a direction running parallel and/or transverse to the access direction in the stowed state. For example, the primary guide element and the secondary guide element are each step-shaped on their outer sides.

It is particularly preferred that the primary limiting element has a recess, in particular in the form of a longitudinally extending groove or slot, in the primary guide element, wherein, in the stowed state, the secondary guide element of the secondary limiting element engages in the recess of the primary limiting element or the secondary guide element reaches through the recess. In the case of reaching through, the secondary limiting element protrudes in a vertical direction relative to the primary limiting element in the stowed state. Preferably, the secondary limiting element engages in the recess in the secondary limiting element in such a way that on an upper side the primary guide element and the secondary guide element are flush with each other. One advantage of the design of this plug-in system is, in particular, that it eliminates the need for hooks or the like for suspending the primary fastening element from the secondary fastening element, which could otherwise potentially pose a risk of injury.

In particular, it is provided that the arrangement comprises a floor-side frame element, the frame element comprising a first strut and a second strut extending parallel to the first strut, the primary limiting element being integrally connected to the first strut and the secondary limiting element being detachably attachable to the second strut. Advantageously, this already provides an arrangement that can be easily integrated or installed as a whole in the access area of an event site, for example by recessing the arrangement into the ground, preferably with the frame element integrated into the ground, for example set in concrete. In an advantageous manner, the arrangement can be used as a kit element to realize a sluice system or a separation system from several such frame elements. In this context, the person skilled in the art understands by an integral design of the primary limiting element with the first strut in particular that the secondary limiting element is connected to the frame element, for example by a material bond, so that it cannot be detached. In contrast, the secondary limiting element of the primary limiting element can be detached from the frame element, wherein preferably the primary limiting element is detachably mounted to the frame element, in particular to the second strut of the frame element. In particular, it is provided that the frame element extends in a direction perpendicular to the access direction over a length having a value between 1.5 m and 2 m, preferably between 1.8 m and 2 m, and particularly preferably about 1.9 m. Furthermore, the level compensation described above can be provided by means of adjustment elements provided on the frame element.

In another embodiment, the frame element includes a third strut extending parallel to the first strut and the second strut, the second strut extending between the first strut and the third strut, and a further secondary limiting member integrally disposed on the third strut.

According to a further embodiment of the present invention, it is provided that the arrangement comprises at least one folding mechanism by means of which the primary limiting element and/or the secondary limiting element is retractable, in particular retractable into the floor. For example, the folding mechanism is a scissor-stage-like system with which the primary guide element and/or the secondary guide element is retractable into the ground, so that the visitors leaving the event area can leave the event area via the retracted primary and/or secondary guide element. It is particularly preferably provided that the folding mechanism is preferably designed in such a way that the primary guide element and/or the secondary guide element performs a substantially vertical movement for transfer to the stowed state or operating state. In particular, it is provided that the folding mechanism can be transferred automatically or manually between a retracted or lowered state and an extended state by means of a motor drive.

A further object of the present invention is the use of an arrangement according to the invention in the access area of an event site. All the features and advantages described for the arrangement can be transferred analogously to the use of the arrangement and vice versa.

According to a further aspect of the present invention, a primary limiting element and/or a secondary limiting element is provided for an arrangement according to the invention. All features and advantages described for the arrangement can be transferred analogously to the primary limiting element and/or secondary limiting element, or vice versa.

Further advantages and features result from the following description of preferred embodiments of the object according to the invention with reference to the attached figures. Individual features of the individual embodiment can be combined with each other within the scope of the invention.

It shows:

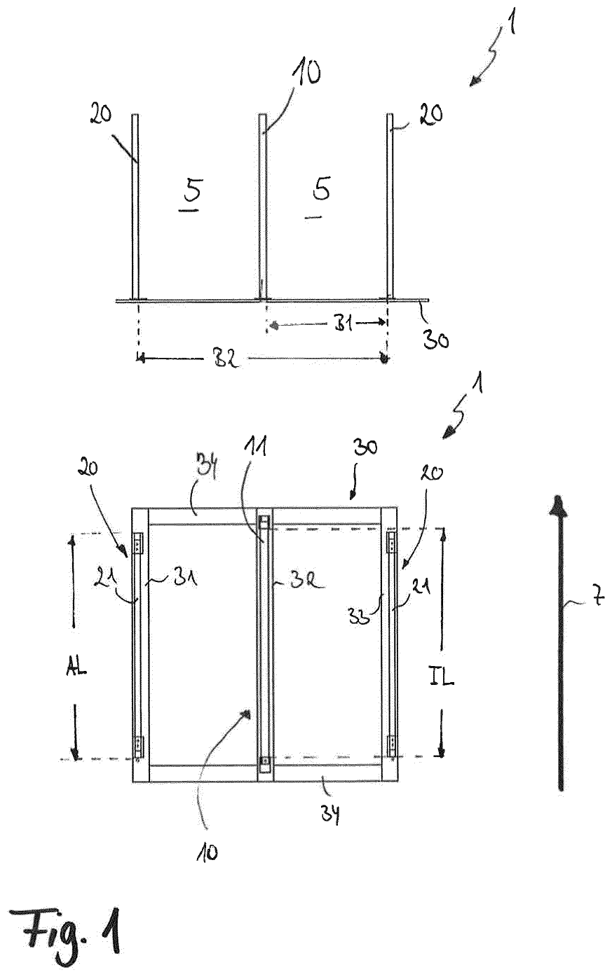

FIG. 1: an arrangement for a sluice system according to a first preferred embodiment of the present invention,

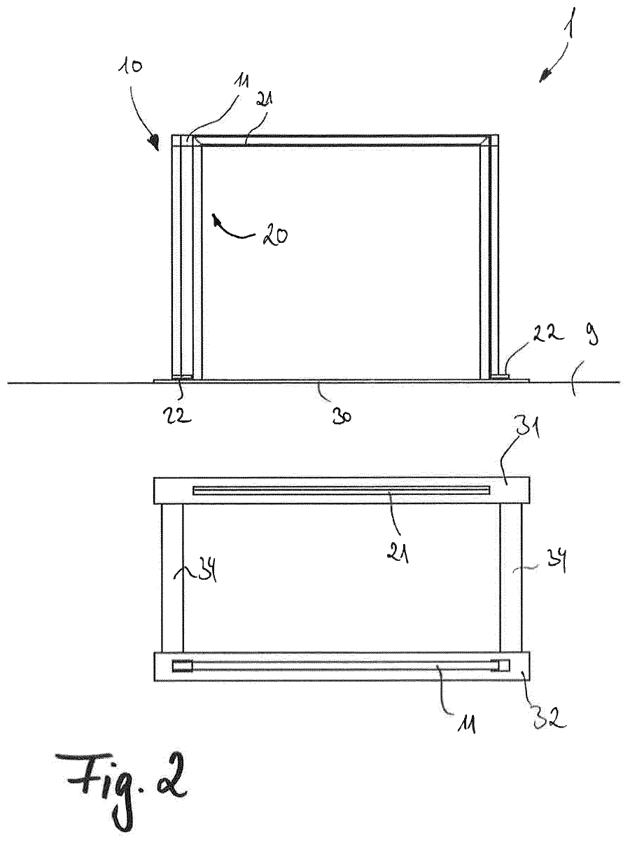

FIG. 2: an arrangement for a sluice system according to a second preferred embodiment of the present invention,

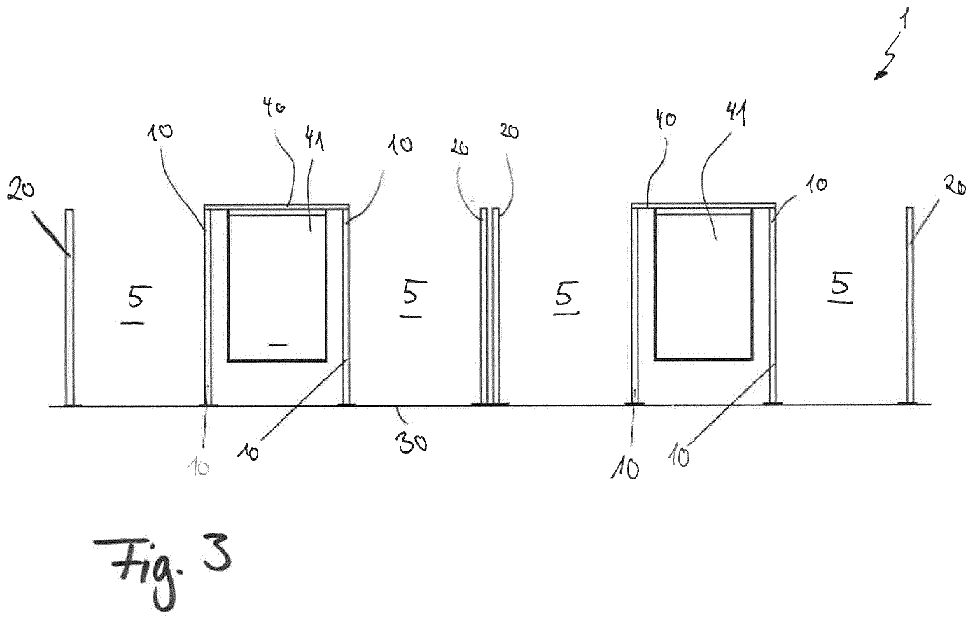

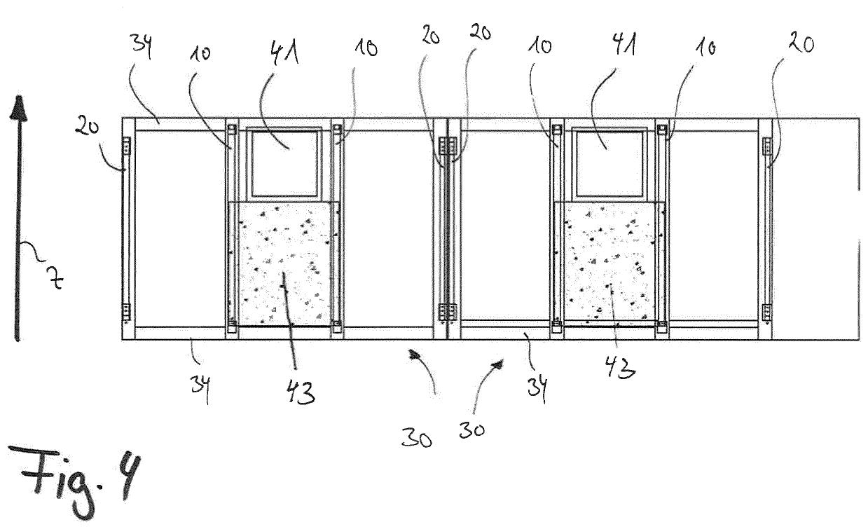

FIGS. 3 and 4: a sluice system of arrangements according to a third preferred embodiment of the present invention,

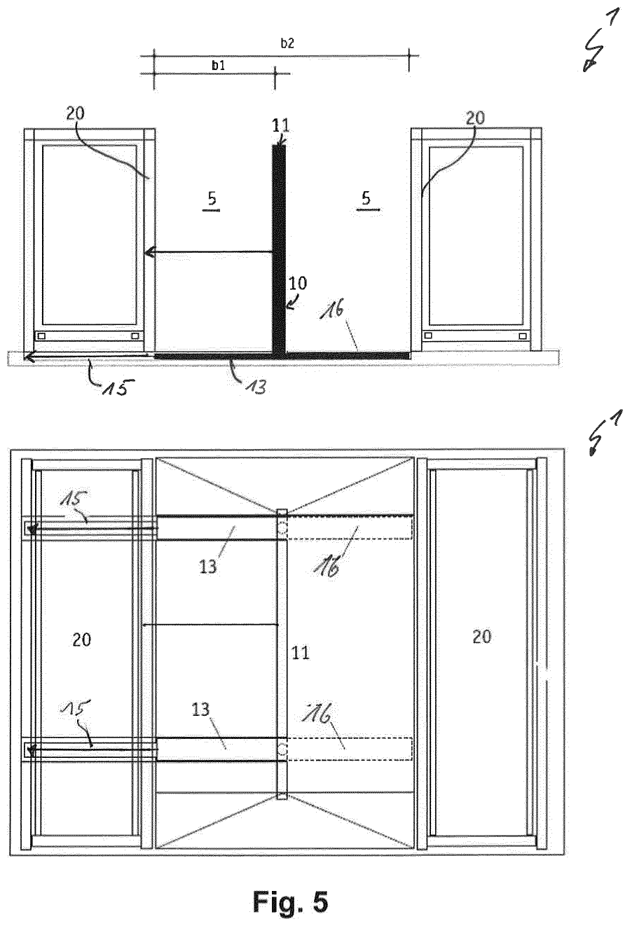

FIG. 5: an arrangement for a sluice system according to a fourth preferred embodiment of the present invention,

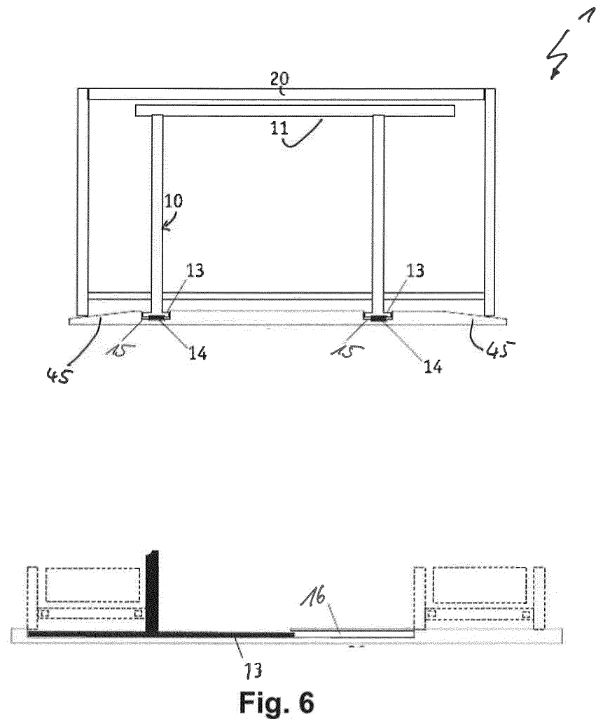

FIG. 6: a side view of the arrangement for the sluice system according to the fourth preferred embodiment of the present invention,

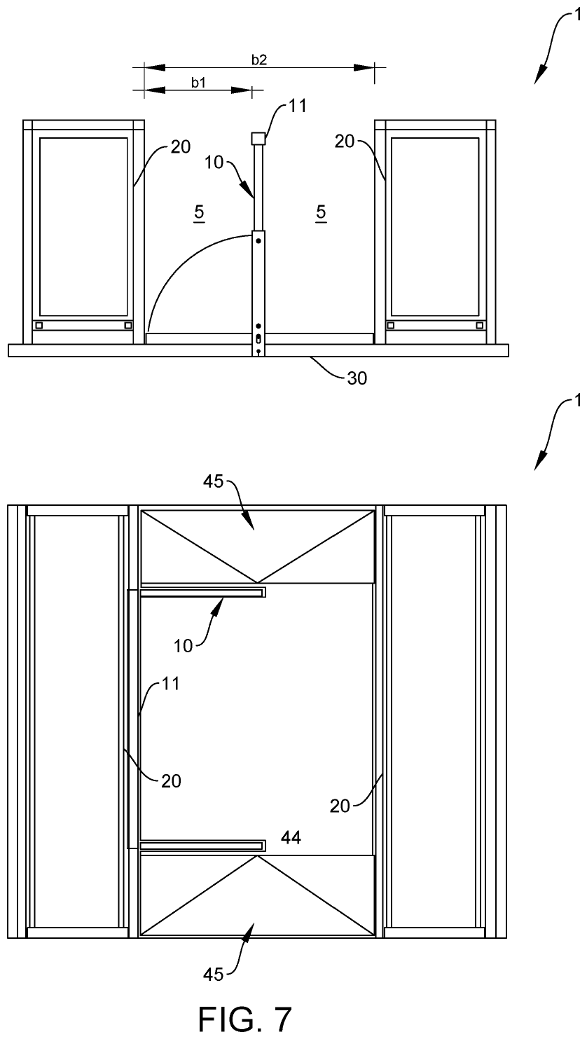

FIG. 7: an arrangement for a sluice system according to a fifth preferred embodiment of the present invention, and

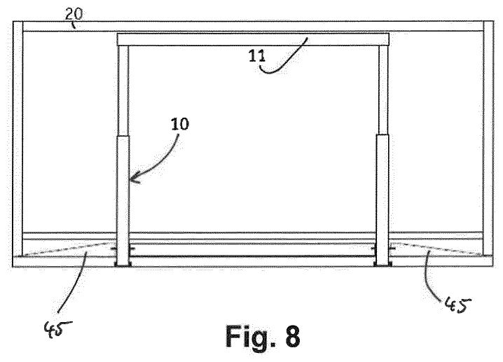

FIG. 8: the arrangement for the sluice system according to the fifth preferred embodiment of the present invention in a side view.

FIG. 1 shows an arrangement 1 for a sluice system or a lock system according to a first preferred embodiment of the present invention. In the embodiment shown in FIG. 1, the upper half of an arrangement 1 is shown in a side view, in particular a side view in the direction of an access direction Z, and the lower half shows a top view of the arrangement 1. In particular, such an arrangement 1 is located in a sluice system or a separation system, respectively, which is found in the access area of an event site. Such a sluice system serves in particular to individually control visitors who want to enter an inner area of the event site from an outer area. The arrangement 1 of a primary limiting element 10 and a secondary limiting element 20 thereby forms a passage 5 through which each visitor must pass before gaining access to the event site. Preferably, security personnel or stewards are positioned at the primary limiting element 10 and/or secondary limiting element 20 to control the individual visitors, e.g. with regard to an access authorization, such as a ticket, or with regard to objects that are not desired or permitted on the event premises. In particular, several passages 5 are arranged next to each other in a direction running perpendicular to an access direction Z.

It is further provided that the primary limiting element 10 encloses a dimensionally stable primary guide element 11 extending longitudinally in the access direction Z and/or that the secondary limiting element 20 encloses a dimensionally stable secondary guide element 21 extending longitudinally in the access direction Z. The primary guide element 11 and the secondary guide element 21 preferably extend parallel to one another. The primary guide elements 11 and secondary guide elements 21, which preferably extend parallel to one another, each laterally limit or delimit the passage 5, which extends longitudinally along the access direction Z. In particular, it is provided that the primary limiting element 10 and the secondary limiting element 20 are arranged in an operating state in such a way that the passage 5 formed between the primary limiting element 10 and the secondary limiting element 20 has a first width B1.

For the easiest possible control, it is desirable to implement a comparatively small first width B1 for the passage 5 in the operating state in order to prevent people from pushing past the security personnel. However, the minimum width of the passage 5 is usually limited by safety regulations, since the passage must be designed to be sufficiently wide, for example for an escape situation, to allow people to leave the event area safely via the passage 5. In order to be able to provide a sufficient passage width for the escape situation, it is provided that the primary limiting element 10 can be converted into a stowed state. This makes it possible to form a second width B2, dimensioned perpendicularly to the direction of access Z, for the passage, which is greater than the first width B1 and is essentially defined by a distance between two secondary limiting elements 20. For this purpose, it is provided in particular that the primary limiting element 10 can be detached from an anchoring, in particular an anchoring to the floor 9, or from a fastening element. In this embodiment, the arrangement 1 of FIG. 1 comprises a frame element 30, to which two secondary limiting elements 20 are attached in addition to the primary limiting element 10 in the operating state. In particular, it is provided that the primary limiting element 10 is arranged centrally between the two secondary limiting elements 20 in a direction extending transversely to the access direction Z. Furthermore, it is preferably provided that the secondary limiting elements 20 are integrally formed with the frame element 30, while the primary fastening element 10 is detachably mounted to a fastening element on the frame element 30. The frame element 30 comprises, for example, a first strut 31, a second strut 32 and a third strut 33, which are preferably connected to one another via two cross struts 34 extending parallel to one another. In particular, it is provided that the first strut 31, the second strut 32 and the third strut 33 extend parallel to each other, preferably along the access direction Z. Furthermore, for the embodiment example shown in FIG. 1, it is provided that the primary limiting element 10 can be detached from the corresponding fastening element on the frame via a quick-release mechanism for transfer to the stowed state and can then be fitted onto one of the secondary fastening elements 20. For this purpose, the primary fastening element 10, in particular the primary guide element 11, is longer in the access direction Z than the secondary limiting element 20, in particular the secondary guide element 21. Preferably, it is provided that the primary fastening element 10 has posts which preferably project perpendicularly from the primary guide element 11, so that the primary limiting element 11 forms a U-shaped bracket-like or railing-like element. The same applies to the secondary fastening elements 20. In this context, it is provided in particular that the primary limiting element 11 has in particular an inner length IL between the posts equal to or greater than an outer length AL between the posts of the secondary fastening element AL. An outer length AL differs from an inner length IL in that the outer length AL is dimensioned on outer side surfaces of the posts as seen in the access direction Z and the inner length IL is dimensioned on inner side surfaces of the posts as seen in the access direction Z. In this way, it is possible that the outer length AL is longer than the inner length IL. Thus, it is possible that in the stowed state the posts of the secondary limiting element 20 are arranged between the posts of the primary limiting element 10, wherein the posts of the primary limiting element 10 and the secondary limiting element 20 are arranged in alignment with each other. Preferably, the inner length IL of the primary limiting element 10 and the outer length AL of the secondary limiting element are designed in such a way that the primary limiting element 10 is arranged on the secondary limiting element 20 in a snug fit and or with clearance adjustment in the stowed state.

In another embodiment not shown, two functional elements 40 are provided outside the two secondary limiting elements 20 in the sluice system shown in FIG. 1. In this case, the two functional elements 40 are each adjacent to one of the two secondary limiting elements 20. In other words, two passages 5 are separated from each other by the primary limiting element 10. In each case, the two passages 5 are delimited outwardly by the secondary limiting elements 20 and the two functional elements 40. The functional elements 40 are each solid bodies that can reduce a back pressure in front of the sluice formed by the arrangement 1 (i.e. in a waiting area).

FIG. 2 shows an arrangement 1 according to a second preferred embodiment of the present invention. The upper half of FIG. 2 shows a side view of an arrangement 1, the direction of view of which is transverse to the direction of access Z, and the lower half shows a top view of the arrangement 1. In contrast to the example in FIG. 1, it is preferably provided that the frame element 30 here has only a first strut 31 and a second strut 32, which are connected to one another via two cross struts 34. Furthermore, it is provided that the secondary guide element 21 has a profiling on its side facing away from the floor 9, which profiling preferably interacts in a form-fitting manner with a profiling on an underside of the primary guide element 21 facing the floor 9 in the stowed state, in particular in a form-fitting manner in a direction extending transversely to the access direction Z. In this way, the stability of the assembled system of primary limiting element 10 and secondary limiting element 20 can be supported in an advantageous manner. Furthermore, it is provided that the primary limiting element 10 comprises foot elements 22, which are arranged at the ends of the posts facing the floor 9. Thereby, the foot elements 22 are formed protruding in the same direction on the post. Preferably, the foot elements 22 extend along the access direction Z.

FIGS. 3 and 4 show a sluice system or a separating system, wherein the sluice system is formed by two arrangements 1 which are arranged next to each other in a direction running transversely to the access direction Z. In particular, it is intended that the respective arrangements 1 are designed in such a way that two primary limiting elements 10 are arranged between the two secondary limiting elements 20. In particular, it is provided that here the respective arrangements 1 are designed in such a way that two primary limiting elements 10 are arranged between the two secondary limiting elements 20. In the selected representation of the FIG. 3 it concerns a side view with a view direction along the access direction Z. Further it is provided that the passages 5 are formed in each case between the primary limiting element 10 and the secondary limiting element 20. In particular, a functional element 40 is provided in the area between the two primary limiting elements 10. The functional element 40 is, for example, a storage space 43 and/or a trash bag attachment to which a trash bag 41 can be attached. Thus, a check-in device is realized between the primary limiting elements 10, which assists a steward in his control of visitors. For example, the storage space 43 allows persons to be checked to place their bag and/or for positioning secured objects. The trash bags can also be used to immediately dispose of beverage bottles or empties, for example, which are not permitted on the event site.

FIG. 4 shows another top view of the sluice system from FIG. 3, and it can be seen that the storage space 43 and the trash bag 41 are arranged between the primary limiting elements 10. In this connection, it is preferably provided that, for example, a garbage bag fastening can be detachably mounted on the primary guide elements 11 of the primary limiting elements 10, for example, can be clipped on. The same applies to the storage space 43. Thus, for transferring the primary limiting elements 10 into the stowed state, the trash bag 41 or trash bag fastening and the stowage space 43 can be easily removed in order to subsequently slip the primary limiting element 10 onto the secondary limiting element 20. In an alternative and/or complementary embodiment, it is preferably provided that the functional element 40, for example the storage space 43 or the trash bag attachment is configured for mounting a trash bag 41 on the primary limiting element 10. In particular, it is provided that the primary limiting element 10 is then revisibly transferable between a use state and a non-use state, for example, the storage space 43 can be mounted on the primary limiting element 10 or on the secondary limiting element 20 in such a way that it can be pivoted or the primary limiting element 10 or the secondary limiting element 20 in such a way that it can be pivoted or folded for transfer to the state of non-use, so that the storage surface 43 can be easily folded down or up for transfer to the state of non-use, wherein the storage surface 43 in a state of non-use runs parallel to a plane along which the primary guide element 21 and the posts of the primary limiting element 21 extend. In particular, it is envisaged that by stringing together frame elements 30 such as those shown in FIGS. 3 and 4, for example, into the sluice system in the assembled state, two secondary limiting elements 20 are arranged side by side or adjacent to each other in a direction transverse to the direction of access Z.

FIG. 5 shows an arrangement 1 according to a fourth preferred embodiment of the present invention. In FIG. 5, the upper half shows an arrangement 1 in a side view, in particular a side view in the direction of view of an access direction Z, and the lower half shows a top view of the arrangement 1. In the embodiment shown in FIG. 5, the primary limiting element 10 and the guide element 11 can be transferred laterally into the stowed state by a translational movement. The base of the limiting element 10 is connected, preferably rigidly connected, to a supporting element 13, in particular a supporting plate. The supporting element 13 can slide on bearings 14 in and/or on a guide 15. The supporting element 13 lies in and/or on the guide 15 in such a way that it is substantially level with the floor structure of the sluice formed by the arrangement. While it lies open in the guide 15 on the left as viewed in the direction of access, it is received in a pocket 16 in the floor structure on the right. Thereby, the pocket 16 at least partially surrounds the supporting element 13. When the limiting element 10 is now moved into the stowed state, the supporting element 13 also slides in and/or on the guide 15 under the secondary limiting element 20, and at the same time the supporting element 13, which is accommodated in the pocket 16 on the right in the operating state, now moves into the left-hand lock area in the stowed state. This ensures that the guide 15 is always closed or covered and does not represent an obstacle or a tripping hazard for pedestrians. Furthermore, it can thus be prevented that objects, impurities or the like get into the guide and thus block and/or damage it. Furthermore, the guide 15 is not open in any state (i.e., neither in the operating state nor in the escape state), so that persons passing through the sluice cannot trip over it. Arrows in FIG. 5 indicate the direction of movement from the operating state to the stowed state.

In FIG. 6, a section along the access direction of the embodiment shown in FIG. 5 is shown in the upper part of the figure. The sluice formed from arrangement 1 has ramps 45 on both sides in the access direction Z, which connect a raised floor area in the central region of the sluice to the surrounding ground level, so that persons can easily enter the sluice without having to climb a large step. Thus, further installation space is created in the floor area of the sluice formed by the arrangement 1. In the sectional view shown in FIG. 6, the supporting element 13 has a substantially rectangular shape so that it almost completely fills the guide 15 in the access direction. Further, the support element 13 may form a substantially T-shaped form with the primary limiting element 10, projecting in a flange-like manner from the primary limiting element 10 at the base of the primary limiting element 10 in the access direction. In this regard, the support element 13 is received in the guide 15 such that it is substantially at the same level as the bottom of the sluice formed from the arrangement. The support element 13 may also be integral with the primary limiting element 10. In the lower portion of FIG. 6, an enlarged section of the upper portion of FIG. 5 is shown. In the condition shown in the lower region of FIG. 6, the primary limiting element 10 is in the stowed state (i.e., in the left position in the access direction). It can be seen that the pocket 16 is empty in this case and the left area of the carrying element 13 in the access direction is located under the secondary limiting element 20 and/or under the functional element 40. In this escape state, fleeing persons can run over the pocket 16 and over the carrying element 13. The guide 15 can, for example, be a guide rail and/or a guide profile.

FIG. 7 shows an arrangement 1 according to a fifth preferred embodiment of the present invention. In the embodiment shown in FIG. 7, an arrangement 1 is shown in the upper half in a side view, in particular in a side view in the direction of an access direction Z, and in the lower half a top view of the arrangement 1 is shown. In the embodiment shown in FIG. 7, the primary limiting element 10 is formed as a telescopic arm and is provided with a folding mechanism at a foot point of the primary limiting element 10. This allows the upper part of the primary limiting element 10 to be lowered together with the guide element 11, and then the lower part of the primary limiting element 10 to be transferred to the stowed state by folding away laterally. The lowering and folding mechanism can be triggered manually or electrically by a corresponding mechanism. In the stowed state, the primary limiting element 10 and the guide element 11 are then accommodated in the floor area of the sluice formed by the arrangement 1, so that persons can pass through the sluice without any problems.

In FIG. 8, the fifth embodiment is shown in a side view transverse to the access direction Z.

Embodiments of the present invention may be combined in whole or in part to obtain new embodiments. In other words, individual features of embodiments may be combined with features of other embodiments.

### REFERENCE SIGNS

1 arrangement
5 passage
9 floor
10 primary limiting element
11 primary guide element
13 supporting element
14 bearing
15 guide
16 pocket
20 secondary limiting element
21 secondary guide element
22 foot element
30 frame element
31 first strut
32 second strut
33 third strut
34 cross strut
40 functional element
41 trash bag
43 storage space
45 ramp
AL outer length
IL inner length
Z access direction
B1 first width
B2 second width

1. Arrangement of at least one primary limiting element and at least one secondary limiting element for a sluice system, in the access area of an event site, wherein the primary limiting element comprises a dimensionally stable primary guide element extending longitudinally in an access direction and/or the secondary limiting element comprises a dimensionally stable secondary guide element extending longitudinally in the access direction, wherein at least the primary limiting element is reversibly transferable between an operating state and a stowed state, wherein in the operating state a passage extending in the access direction is formed between the primary limiting element and the secondary limiting element, and wherein for widening the passage in the stowed state at least the primary limiting element, in particular the entire primary limiting element, is stowed.

2. Arrangement according to claim 1, wherein the primary and/or secondary limiting element comprises a quick release mechanism for releasing the primary and/or secondary limiting element from a fastening element to which the primary and/or secondary limiting element is fastened in the operating state.

3. Arrangement according to claim 1, wherein in the stowed state the primary or secondary limiting element is suspended from the secondary or primary limiting element, respectively, or at least the primary limiting element is retracted in the floor.

4. Arrangement according to claim 1, wherein the primary limiting element and/or the secondary limiting element comprises a functional element, comprising at least one of a storage space, a folding chair element and/or a garbage bag fastening, which is transferable between a state of use and a state of non-use and/or the functional element is connected to the primary limiting element and/or the secondary limiting element at least in the operating state.

5. Arrangement according to claim 1, wherein the primary or secondary limiting element is dimensioned larger, such that the primary or secondary limiting element can be plugged onto the secondary or primary limiting element.

6. Arrangement according to claim 1, wherein, in the stowed state, the primary guide element and the secondary guide element (12) interact in a form-fitting manner in a direction running parallel and/or transverse to the access direction.

7. Arrangement according to claim 1, wherein the primary limiting element has a recess, in the form of a longitudinally extending groove, in the primary guide element, wherein, in the stowed state, the secondary guide element of the secondary limiting element (20) engages in the recess or the secondary guide element of the secondary limiting element reaches through the recess.

8. Arrangement according to claim 1, wherein the arrangement comprises a floor-side frame element, the frame element comprising a first strut and a second strut extending parallel to the first strut, wherein the secondary limiting element is integrally connected to the first strut and the primary limiting element is detachably attachable to the second strut.

9. Arrangement according to claim 1, wherein the arrangement comprises at least one folding mechanism by means of which the primary limiting element and/or secondary limiting element (20) is retractable, in particular is retractable in the floor.

10. Arrangement according to claim 1 configured for an access area of an event site.

11. Primary limiting element and/or secondary limiting element for an arrangement according to claim 1.
